(19) United States
(12) Patent Application Publication
(10) Pub. No.: US 2022/0394440 A1
(43) Pub. Date: Dec. 8, 2022

(54) METHOD AND DEVICE FOR TRANSMITTING DATA FOR A VEHICLE

(71) Applicant: PSA AUTOMOBILES SA, Poissy (FR)

(72) Inventors: Sharique KHAN, SCEAUX (FR); Alexandre FROMION, ANTONY (FR)

(21) Appl. No.: 17/776,046

(22) PCT Filed: Oct. 16, 2020
(86) PCT No.: PCT/FR2020/051854

§ 371 Date: May 11, 2022

(30) Foreign Application Priority Data
Nov. 25, 2019 (FR) 1913168

(51) Int. Cl. H04W 4/40; H04W 80/02

(52) U.S. Cl. CPC H04W 4/40; H04W 80/02

(57) ABSTRACT

The invention relates to a method and a device for transmitting data for a vehicle, in particular in a V2X communication network. For this purpose, a data frame (2) is transmitted in a vehicle-to-everything (V2X) communication mode. The frame (2) advantageously comprises a series (200) of a plurality of identical and consecutive data packets (21 to 24) in the data frame, each packet (21 to 24) comprising the same set of identical data.

### CROSS-REFERENCE TO RELATED APPLICATIONS

This application is the US National Stage under 35 USC § 371 of International Application No. PCT/FR2020/051854, filed 16 Oct. 2020 which claims priority to French Application No. 1913168 filed 25 Nov. 2019, both of which are incorporated herein by reference.

### BACKGROUND

The invention relates to data transmission methods and devices for vehicles, in particular of the automotive type. The invention relates more particularly to a method and a device for transmitting data according to a communication mode of the vehicle-to-everything (V2X) type, in particular for transmitting emergency or alert messages.

### TECHNOLOGICAL BACKGROUND

Modern vehicles carry communications systems allowing the vehicles to exchange information amongst themselves or with their environment, in particular information associated with alert or emergency messages to warn of a danger, for example.

Thus, new information and communication technologies applied to the transportation field have appeared, such as the ITS G5 (“Intelligent Transportation System G5”) in Europe or DSRC (“Dedicated Short Range Communications”) in the United States of America, which are both based on the IEEE 802.11p standard, or technology based on cellular networks called C-V2X (“Cellular—Vehicle-to-Everything”), which relies on 4G based on LTE (“Long Term Evolution”) and soon 5G.

Since vehicles are mobile by definition, the transmission of data is sometimes accompanied by errors and/or loss of information, for example due to temporary loss of connection. These transmission problems can prove to be particularly harmful when, for example, the data transmitted by a vehicle relates to an alert or emergency message to warn road users of an imminent danger.

### SUMMARY OF THE INVENTION

In view of the foregoing, disclosed is a method is to secure the transmission of data in a communication system of the vehicle-to-everything (V2X) type.

An object of the method is to improve the reliability of data transmission by a vehicle, in particular for data relating to an emergency or distress.

According to a first aspect, the data transmission method for a vehicle comprises transmitting a data frame in a vehicle-to-everything (V2X) communication mode, the frame comprising a series of several identical and consecutive packets in the frame.

According to a variant, a different error detection code is associated with each of the packets of the series.

According to another variant, a different error correction code is associated with each of the packets of the series.

According to an additional variant, each packet of the series comprises the same set of identical data representative of an emergency message or of an alert message.

According to an additional variant, the data of the data set correspond to message data of the CAM or DENM type.

According to yet another variant, a transmission time slot is associated with each packet of the series, the series forming a group of transmission time slots.

According to another variant, a number of identical packets comprised in said series is determined from a transmission performance indicator.

In particular, in one embodiment, the performance indicator comprises at least one element from among:
a packet error rate;
a frame error rate;
a number of acknowledgments;
a number of non-acknowledgments.

Also discloses is a data transmission device for a vehicle, the device comprising a memory associated with a processor configured to implement the steps of the method described briefly above.

According to an aspect, the device is incorporated in a vehicle, such as an automobile.

According to another aspect, a computer program comprises instructions suitable for executing the steps of the method, in particular when the computer program is executed by at least one processor.

Such a computer program may use any programming language, and be in the form of source code, object code, or intermediate code between source code and object code, such as in a partially compiled form, or in any other desirable form.

According to a further aspect, the computer program is recorded on a computer-readable recording medium, the computer program comprising instructions for executing the steps of the method.

On the one hand, the recording medium may be any entity or device capable of storing the program. For example, the medium may comprise a storage means, such as a ROM memory, a CD-ROM or a ROM memory of the microelectronic circuit type, or even a magnetic recording means or a hard disk.

On the other hand, this recording medium may also be a transmissible medium such as an electrical or optical signal, such a signal being able to be conveyed via an electrical or optical cable, by conventional or hertzian radio or by self-directed laser beam or by other means. The computer program according to the invention may in particular be downloaded from an Internet-type network.

Alternatively, the recording medium may be an integrated circuit in which the computer program is incorporated, the integrated circuit being suitable for executing or being used in the execution of the method in question.

### BRIEF DESCRIPTION OF THE FIGURES

Other features and advantages of the invention will emerge from the description of the non-limiting embodiments of the invention below, with reference to the appended FIGS. 1 to 4, in which:

FIG. 1 schematically illustrates a V2X communication environment;

FIG. 2 schematically illustrates the structure of a data frame transmitted by a vehicle of the communication environment of FIG. 1;

FIG. 3 schematically illustrates a device configured to transmit the data frame of FIG. 2; and

FIG. 4 illustrates a flowchart of the different steps of a data transmission method for a vehicle in the environment of FIG. 1.

### DESCRIPTION OF THE EMBODIMENTS

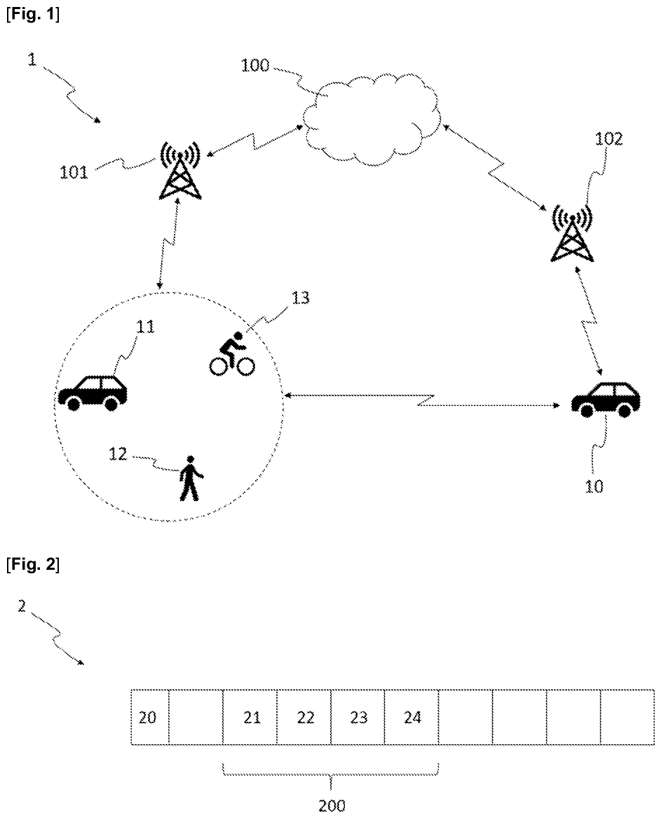

A method and a data transmission device for a vehicle, in particular in a V2X-type communication network, will now be described in the following with joint reference to FIGS. 1 to 4.

According to a particular and non-limiting embodiment, a data transmission method, in particular in a V2X-type communication network, comprises transmitting one or more data frames in a vehicle-to-everything (V2X) communication mode. Each frame advantageously comprises a series of several identical and consecutive data packets in the data frame, each packet comprising a same set of identical data.

Concatenating several identical packets in the same data frame transmitted to one or more recipients allows improved security of the transmission, that is to say, an increased probability that the data contained in the packets are actually received by the recipient(s).

FIG. 1 schematically illustrates a communication environment 1 in a communication network of the V2X (“Vehicle-to-everything”) type, according to a particular and non-limiting embodiment.

FIG. 1 illustrates a first vehicle 10 traveling in a road environment. The first vehicle 10 advantageously includes a communication device to transmit and receive data intended for another communication device, for example a communication device of a second vehicle 11 or carried by a pedestrian 12 or by a cyclist 13. Each communication device may be likened to a node of a network, for example an ad hoc wireless network.

The first vehicle 10 transmits information or data to the second vehicle, the pedestrian 12 and/or the cyclist 13 using a vehicle-to-everything (V2X) communication system, for example based on the 3GPP LTE-V or IEEE 802.11p ITS G5 standards. In such a V2X communication system, each vehicle carries a node to allow communication from vehicle to vehicle (V2V), from vehicle to infrastructure (V2I) and/or from vehicle to pedestrian (V2P), the pedestrians (or cyclists) being equipped with mobile devices (for example a smartphone) configured to communicate with vehicles.

A wireless ad hoc network (also called ET WAN (Wireless Ad Hoc Network) or MANET (Mobile Ad Hoc Network)) is a decentralized wireless network. Unlike a centralized network that is based on an existing infrastructure comprising, for example, routers or access points linked together by a wired or wireless infrastructure, the ad hoc wireless network is made up of nodes that each participate in the data routing by retransmitting data from one node to another, from the sender to the receiver, depending on the network connectivity and the routing algorithm implemented. The ad hoc wireless network advantageously corresponds to a vehicular ad hoc network (VANET) or to an intelligent vehicular ad hoc network (InVANET), also known as a “GeoNetworking” network. In such a network, two or more vehicles each carrying a node of the ad hoc wireless network can communicate with one another in the context of vehicle-to-vehicle (V2V) communication; each vehicle can communicate with the infrastructure set up within the framework of vehicle-to-infrastructure (V2I) communication; each vehicle can communicate with one or more pedestrians equipped with mobile devices (for example a smartphone) as part of a vehicle-to-pedestrian (V2P) communication.

The ad hoc wireless network comprises transmission relays 101, 102 corresponding for example to one or more RSUs (“Road Side Unit”) 101, 102, each corresponding to a node of the network, in addition to the nodes equipping vehicles or pedestrians. According to a variant, the transmission relays 101, 102 correspond to relay antennas of a cellular network, for example a so-called 4G or 5G cellular network. According to yet another variant, the ad hoc wireless network comprises one or more RSUs and one or more relay antennas of a cellular network, in addition to the nodes equipping vehicles or pedestrians. According to this variant, the node 101 corresponds, for example, to an RSU and the node 102 to a relay antenna.

The relays 101 and 102 are advantageously connected to one or more remote servers or to the cloud 100 via a wired and/or wireless connection. The relays 101 and 102 can thus act as a relay between the cloud 100 and the first vehicle 10, the second vehicle 11, the pedestrian 12 and/or the cyclist 13.

According to a variant embodiment, the first vehicle 10 transmits data to the second vehicle 11, the pedestrian 12 and/or the cyclist 13 in a direct communication mode, that is to say, without going through the network infrastructure (comprising relays 101 and 102). A direct communication mode is for example compliant with:
ITS G5 in Europe or DSRC (Dedicated Short Range Communications) in the United States of America, both of which are based on the IEEE 802.11p standard; or
LTE-V Mode 4 (“Long-Term Evolution—Vehicle Mode 4”), which allows V2V communications, also called “sidelink” communications, based on a direct LTE communication interface called PC5; such technology is described for example in the article entitled “Analytical Models of the Performance of C-V2X Mode 4 Vehicular Communications,” written by Manuel Gonzalez-Martin, Miguel Sepulcre, Rafael Molina-Masegosa and Javier Gozalvez, and published in 2018.

In a first operation, a data frame comprising a series of identical data packets is formed by the first vehicle 10. This data frame corresponds for example to the data frame described with reference to FIG. 2. The data packets are said to be identical in that the data that each of these packets carries is identical. The number of identical packets in the series is for example between 2 and 10, for example equal to 2, 3, 4, 5 packets.

Each packet of the series advantageously comprises data representative of an emergency and/or alert and/or distress message, these data allowing the recipient(s) of the data frame to be warned of a danger or an emergency. These data correspond, for example, to data from one or more messages of the DENM (“Decentralized Environmental Notification Message”) type as defined in technical specification ETSI TS 102 637-3 v1.1.1 from September 2010. According to another example, these data correspond for example to data from one or more messages of the CAM (“Cooperative Awareness Message”) type as defined in technical specification ETSI TS 102 637-2 v1.2.1 from March 2011.

The data packets are grouped together so as to be consecutive in the data frame, that is to say, the data packets of the series are for example grouped together in a transmission burst or in a transmission time interval bundling (“TTI bundling”), a transmission time interval, TTI, (for example, equal to 40 ms), being associated with or allocated to each data packet of the series.

The number of packets in the series corresponds for example to a default parameter, this number being fixed whatever the situation.

According to a variant, the number of packets in the series corresponds to a parameterizable value, for example by a user.

According to yet another variant, the number of packets in the series is a parameter that can be configured dynamically and automatically by the device constructing the data frame. According to this last variant, the number of packets comprised in the series is determined according to the transmission or connection quality conditions between the first vehicle 10 on the one hand and the recipient(s) of the frame on the other hand.

According to another variant, a number of identical packets comprised in said series is determined from a transmission performance indicator. The performance indicator thus corresponds to a parameter expressing the transmission quality conditions.

In particular, in one embodiment, the performance indicator comprises at least one element from among:
a packet error rate (see below);
a frame error rate (see below);
a number of acknowledgments (see below);
a number of non-acknowledgments (see below).

The performance indicator is for example evaluated by the device constructing the frame (and carried in the first vehicle 10) from indicators such as the PER (“Packet Error Rate”), the FER (“Frame Error Rate”) and the number of acknowledgments or non-acknowledgments received. These indicators are for example determined from frames or data packets previously transmitted by the first vehicle 10, according to the returns done by the recipient(s) of the frames or data packets previously transmitted. The better the connection (low PER and/or FER for example, or high number of acknowledgments compared to the number of packets previously transmitted), the lower the number of packets in the series (for example 2 or 3 identical packets in the series). Conversely, the worse the connection (high PER and/or FER for example, or low number of acknowledgments (or high number of non-acknowledgments) compared to the number of packets previously transmitted), the greater the number of packets in the series is (e.g. 4 or 5 identical packets in the series)

In a second operation, the frame comprising the series of identical packets is transmitted in a V2X communication mode, for example in a direct communication mode. The frame is for example transmitted in a broadcast transmission mode, that is to say, intended for the assembly of all the communication devices configured to communicate with the first vehicle 10 in the V2X communication mode. This assembly for example comprises the second vehicle 11, the pedestrian 12 and the cyclist 13 and is illustrated with a dotted circle in FIG. 1. According to another example, the frame is transmitted in a multicast transmission mode, that is to say, intended for several communication devices each identified by their address. According to yet another example, the frame is transmitted in a unicast transmission mode, that is to say, intended for a single communication device identified by its address (for example, the communication device carried by the pedestrian 12). The transmission mode is for example a function of the nature of the data comprised in the data packets of the series.

The consecutive transmission of several identical packets allows a significant increase in the probability that the data contained in these packets will actually be received and decoded by the recipient(s) of these data packets.

Furthermore, the consecutive transmission of several identical packets allows a considerable reduction in the latency time between two data packets. In the state of the art, it is known to retransmit a data packet when the previously transmitted packet has not been received, at least in part, or when the data of the previously transmitted packet was not able to be decoded correctly. The new transmission generally follows the reception of a message from the recipient indicating to the transmitter that the packet has not been received or has not been decoded, for example via the transmission of a non-acknowledgment, called No-ACK or NACK. The latency time between the transmission of the first packet and the transmission of the second packet is then particularly long, which is very problematic when the data contained in the packets relate to emergency or distress situations. With the consecutive transmission of several identical data packets, the latency is reduced to a minimum. If the recipient has not received the first packet in the series correctly, it will immediately receive the following packets in the series without requesting them, which increases the probability of receiving and decoding all the data, even if there are errors on some packages. The reliability of the connection is thus greatly improved.

To further increase the reliability of the connection, according to a variant embodiment, a different error detection code is associated with each of the packets in the series. Such an error detection code corresponds for example to a CRC (“Cyclic Redundancy Check”).

According to yet another variant, different error correction bits are associated with each packet. Such a variant allows improved reliability of the data transmission by increasing the probability that the data of the packets partially transmitted or transmitted with errors can be reconstructed from the data correctly received. These bits correspond, for example, to FEC (“Forward Error Correction”) data or to a Reed-Solomon code.

FIG. 2 schematically illustrates the structure of a data frame 2 transmitted by the first vehicle 10 to one or more recipients in the communication environment of FIG. 1.

The frame 2 corresponds for example to a data frame conforming to the TCP protocol, such a protocol being described in document RFC 793 (“Requests For Comments”). The frame 2 (also called a segment) corresponds to a sequence of binary values, only the elements specific to the invention being shown in FIG. 2.

The frame 2 comprises a frame header 20 followed by several data packets or segments. Each data packet is for example compliant with the “GeoNetworking” protocol, the structure of such a data segment for example being described in document ETSI TS 102 636-4-1. A data segment is also called a data packet, for example described by the acronym GN-PDU (“GeoNetworking Protocol Data Unit”).

Data segments intended for the same recipient (or several same recipients) are encapsulated in the data frame 2.

According to another example, the data segments of the frame 2 correspond to data packets of message(s) transmitted by the same vehicle (for example the first vehicle 10) intended for a cloud server (for example, message data relating to emergency braking and an immediate danger that the first vehicle is approaching).

The data frame 2 advantageously comprises a series 200 of several packets 21, 22, 23, 24 of identical data arranged consecutively in the data frame 2. In other words, the data packet 21 comprises the same data as each of the other packets 22 to 24, each packet transporting the same set of data.

The series 200 of packets 21 to 24 advantageously corresponds to a TTI grouping 200. A transmission time interval, called TTI, is advantageously associated with each packet 21 to 24 for the transmission of each packet 21 to 24. The duration of the interval is for example equal to 10, 20 or 40 ms.

Each data packet 21 to 24 comprises the same data, which advantageously corresponds to data relating to emergency, alert, distress and/or security messages. These data are for example message data of the CAM and/or DENM type. These data are for example encoded in the GN-PDU data packets by using encoding rules of the UPER (“Unaligned Packed Encoding Rules”) type of standard ASN.1 (“Abstract Syntax Notation One”).

According to a particular embodiment variant, a different error detection code is associated with each packet 21 to 24.

According to another particular embodiment variant, a different error correction code is associated with each packet 21 to 24.

The structure of such a frame allows the consecutive transmission (from a temporal point of view) of each of the packets 21 to 24, the transmission of the first packet 21 being followed by the transmission of the second packet 22, which is followed by the transmission of the third packet 23, which in turn is followed by the transmission of the fourth packet 24 of the series 200.

Of course, the number of packets of the series 200 is not limited to 4, but extends to any number, for example 2, 3, 5, 6 or more packets.

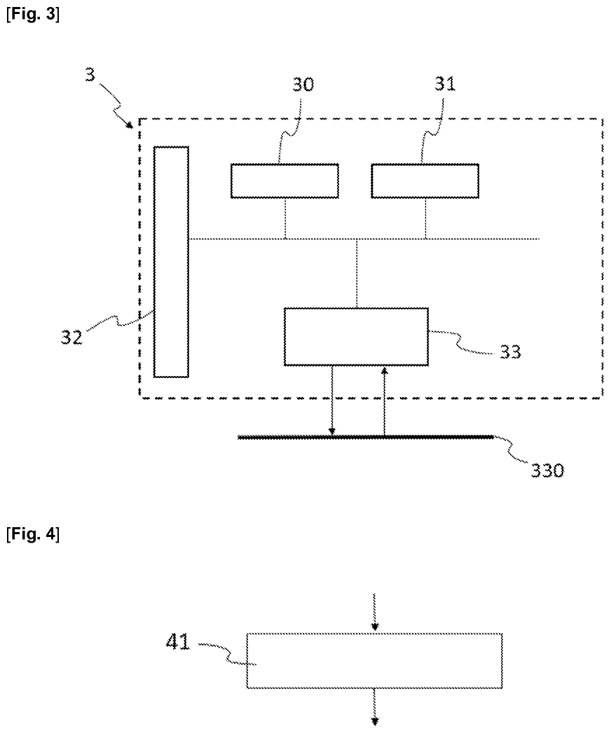

FIG. 3 schematically illustrates a device 3 configured to transmit data in the communication environment of FIG. 1, according to a particular and non-limiting embodiment. The device 3 corresponds for example to a node on board the vehicle 10 or the vehicle 11 or to a node carried by a pedestrian, for example a smartphone. The device 3 is for example configured to transmit the data comprised in the frame 2. According to a variant, the device 3 is further configured to construct and generate the data frame 2 of FIG. 2.

The device 3 is for example configured to implement the operations described with regard to FIGS. 1 and 2 and/or the steps of the method described with regard to FIG. 4. Examples of such a device 3 comprise, but are not limited to, on-board electronic equipment such as a vehicle's on-board computer, an electronic computer such as an ECU (“Electronic Control Unit”), a roadside unit, a smartphone, a tablet, a laptop, a server. The elements of the device 3, individually or in combination, can be integrated in a single integrated circuit, in several integrated circuits and/or in discrete components. The device 3 can be produced in the form of electronic circuits or of software (or computer) modules, or else of a combination of electronic circuits and software modules. According to various particular embodiments, the device 3 is coupled in communication with other devices or similar systems, for example by means of a communication bus or through dedicated input/output ports.

The device 3 comprises one (or more) processor(s) 30 configured to execute instructions for carrying out the steps of the method and/or for executing the instructions of the software embedded in the device 3. The processor 30 can include integrated memory, an input/output interface and various circuits known to those skilled in the art. The device 3 further comprises at least one memory 31 corresponding for example to a volatile and/or non-volatile memory and/or comprises a memory storage device that can comprise volatile and/or non-volatile memory, such as EEPROM, ROM, PROM, RAM, DRAM, SRAM, flash, magnetic or optical disk.

The computer code of the on-board software application(s) comprising the instructions to be loaded and executed by the processor is for example stored in the first memory 31.

According to a particular and non-limiting embodiment, the device 3 comprises a block 32 of interface elements for communicating with external devices, for example a remote server or the cloud, other nodes of the ad hoc network. The interface elements of the block 32 comprise one or more of the following interfaces:
radiofrequency (RF) interface, for example of the Bluetooth® or Wi-Fi®, LTE (“Long-Term Evolution”), LTE-Advanced type;
USB (“Universal Serial Bus”) interface;
HDMI interface (“High-Definition Multimedia Interface”).

Data are for example loaded into the device 3 via the interface of the block 32 using a Wi-Fi® network such as according to IEEE 802.11, an ITS G5 network based on IEEE 802.11p or a mobile network such as a 4G (or LTE Advanced according to 3GPP release 10—version 10) or 5G network, in particular an LTE-V2X network.

According to another particular embodiment, the device 3 comprises a communication interface 33 that allows communication to be established with other devices (such as other computers of the on-board system when the device 3 corresponds to a computer of the on-board system) via a communication channel 330. The communication interface 33 for example corresponds to a transmitter configured to transmit and receive information and/or data via the communication channel 330. The communication interface 33 corresponds for example to a wired network of the CAN (“Controller Area Network”) or CAN FD (“Controller Area Network Flexible Data-Rate”) type.

According to an additional particular embodiment, the device 3 can supply output signals to one or more external devices, such as a display screen, one or more loudspeakers and/or other peripherals respectively via output interfaces, not shown.

FIG. 4 illustrates a flowchart of the different steps of a data transmission method for a vehicle, according to a particular and non-limiting embodiment. The method is for example implemented by a device on board the vehicle 10 or by the device 3 of FIG. 3.

In a first step 41, a data frame is transmitted according to a vehicle-to-everything (V2X) communication mode. This data frame advantageously comprises a series of several identical and consecutive packets in the frame.

The data frame is for example received from a memory or from a device configured to construct the data frame.

Of course, the claimed invention is not limited to the embodiments described above, but extends to a method for generating a data frame comprising the series of identical packets and to the device configured to implement the frame generation method.

The claimed invention also concerns a method for receiving a data frame comprising a series of identical and consecutive data packets, and the associated data frame reception device.

The claimed invention also relates to a vehicle, for example an automobile or more generally a land motor vehicle, comprising the device 3 of FIG. 3.

1. A data transmission method for a vehicle, the method comprising transmitting a data frame in a vehicle-to-everything (V2X) communication mode, said frame comprising a series of several identical and consecutive packets in said frame.

2. The method according to claim 1, wherein a different error detection code is associated with each of the packets of said series.

3. The method according to claim 1, wherein a different error correction code is associated with each of the packets of said series.

4. The method according to claim 1, wherein each packet of said series comprises the same set of identical data representative of an emergency message.

5. The method according to claim 4, wherein said data of said set of data correspond to message data of the CAM or DENM type.

6. The method according to claim 1, wherein a transmission time slot is associated with each packet of said series, said series forming a group of transmission time slots.

7. The method according to claim 1, wherein a number of identical packets comprised in said series is determined from a transmission performance indicator.

8. The method according to claim 7, wherein the performance indicator comprises at least one element from among:
a packet error rate;
a frame error rate;
a number of acknowledgments;
a number of non-acknowledgments.

9. A data transmission device for a vehicle, said device comprising a memory associated with a processor configured to implement the steps of the method according to claim 1.

10. A vehicle comprising the device according to claim 9.

11. A computer program product comprising instructions suitable for executing the steps of the method according to claim 1, when the computer program is executed by at least one processor.
